(19) United States
(12) Patent Application Publication
(10) Pub. No.: US 2025/0103443 A1
(43) Pub. Date: Mar. 27, 2025

(54) GLOBAL SNAPSHOT UTILIZATION

(71) Applicant: HITACHI, Ltd., Tokyo (JP)

(72) Inventors: Hiroyuki OSAKI, Los Gatos, CA (US); Tomohiro KAWAGUCHI, Santa Clara, CA (US)

(21) Appl. No.: 18/372,906

(22) Filed: Sep. 26, 2023

(51) Int. Cl. G06F 11/14; G06F 16/23; G06F 16/27

(52) U.S. Cl. CPC G06F 11/1469; G06F 11/1464; G06F 16/2308; G06F 16/27; G06F 2201/84

(57) ABSTRACT

A method for remote snapshot restoration is provided. The method may include receiving a snapshot restore request; determining if the received snapshot restore request satisfies a three-way connection requirement by determining if the received snapshot restore request satisfies host-device-device connection information, wherein the host-device-device connection information comprises host information, source storage device information, destination storage device information, application-volume path information, and volume-volume path information; and for the received snapshot restore requesting satisfying the three-way connection requirement, performing snapshot restoration and data copying.

### BACKGROUND

### Field

The present disclosure is generally directed to a method and a system for remote snapshot restoration.

### Related Art

Snapshot utilization is a process that allows an application operator to restore an old volume data from snapshot and use the restored volume data. FIG. 1 illustrates an example conventional storage system. Storage devices contain volumes and associated snapshots. As illustrated in FIG. 1, storage device 10 contains volume V1 and a snapshot V1_01 associated with V1. A snapshot V1_01 is an old version of volume V1 data, with V1_01 created at a timestamp prior to V1's creation. As illustrated in FIG. 1, snapshot utilization enables application operators to restore the old data as a new volume V1′ from snapshot V1_01.

Snapshot utilization is useful to recover data from data corruption in case of application software bug, malware infection, fraud operations, etc. An application operator can select a snapshot which was created before data corruption occurred, restore the snapshot as a new volume, reconfigure application to use the new volume, and restart application to recover from data corruption.

The snapshot technology allows snapshot creation and restoration only on the same device. As illustrated in FIG. 1, volume V1 and snapshot V1_01 are inside the same storage device 10. Snapshot utilization is also limited to the same device 10, therefore restored data V1′ can only be created in the same device 10. Thus, rendering data restoration of data in a different storage device, such as storage device 20, impossible.

In the current storage systems, storage devices have different performance profiles and different costs depending on their locations. For example, storage device 10 may be a high-performance and high-cost model located inside an on-premise data center. On the other hand, storage device 20 may be a low-performance and low-cost model located inside a public cloud.

In spite of the feasibility of current snapshot technology, it is desirable to restore snapshot data in storage device/location that is different from a location of original volume and snapshot. The choice of a low-cost storage device for performance of snapshot restoration can lower the total cost for applications. In addition, it would be useful to meet an application operator's needs for application testing or data analysis using prior data versions.

In the related art, a method for volume migration across storage device using multipath software is disclosed. During the migration process of a volume, volume data is scattered in both of the source volume and the destination volume. Some data portions used by the application may be in the source volume or may be in the destination volume. Application access to both the source volume and the destination volume must be maintained. However, network connection cannot be guaranteed between application and these volumes. As such, network failure becomes an issue.

In the related art, a method for volume copying across storage device is disclosed. During the snapshot utilization process, the application must wait for data copying to be completed before the application can be started. The wait time may be an hour or more, depending on volume size. At the same time, copying of all possible volume snapshots to possible destinations, whether the copied volume snapshot is used by the application or not, may incur significant total cost increase in storage consumption by storing unused copies across multiple storage devices.

### SUMMARY

Aspects of the present disclosure involve an innovative method for remote snapshot restoration. The method may include receiving a snapshot restore request; determining if the received snapshot restore request satisfies a three-way connection requirement by determining if the received snapshot restore request satisfies host-device-device connection information, wherein the host-device-device connection information comprises host information, source storage device information, destination storage device information, application-volume path information, and volume-volume path information; and for the received snapshot restore requesting satisfying the three-way connection requirement, performing snapshot restoration and data copying.

Aspects of the present disclosure involve an innovative non-transitory computer readable medium, storing instructions for remote snapshot restoration. The instructions may include receiving a snapshot restore request; determining if the received snapshot restore request satisfies a three-way connection requirement by determining if the received snapshot restore request satisfies host-device-device connection information, wherein the host-device-device connection information comprises host information, source storage device information, destination storage device information, application-volume path information, and volume-volume path information; and for the received snapshot restore requesting satisfying the three-way connection requirement, performing snapshot restoration and data copying.

Aspects of the present disclosure involve an innovative server system for remote snapshot restoration. The method may include receiving a snapshot restore request; determining if the received snapshot restore request satisfies a three-way connection requirement by determining if the received snapshot restore request satisfies host-device-device connection information, wherein the host-device-device connection information comprises host information, source storage device information, destination storage device information, application-volume path information, and volume-volume path information; and for the received snapshot restore requesting satisfying the three-way connection requirement, performing snapshot restoration and data copying.

Aspects of the present disclosure involve an innovative system for remote snapshot restoration. The system may include means for receiving a snapshot restore request; means for determining if the received snapshot restore request satisfies a three-way connection requirement by determining if the received snapshot restore request satisfies host-device-device connection information, wherein the host-device-device connection information comprises host information, source storage device information, destination storage device information, application-volume path information, and volume-volume path information; and for the received snapshot restore requesting satisfying the three-way connection requirement and means for performing snapshot restoration and data copying.

Aspects of the present disclosure involve an innovative method for remote snapshot restoration. The method may include receiving a snapshot restore request from host cluster view; transferring the snapshot restore request to a global snapshot utilization module; determining, at the global snapshot utilization module, if the received snapshot restore request satisfies a three-way connection requirement; for the received snapshot restore requesting satisfying the three-way connection requirement, performing snapshot restoration by creating volume associated with the snapshot restore request as source volume in a first storage device; concurrently executing data copying from the source volume to a destination volume in a second storage device while enabling an application to access data stored in the source volume and the destination volume; triggering application deployment operation to enable an application to be deployed in a host cluster management module associated with the second storage device; and deleting the source volume when data copying from the source volume to a destination volume is completed.

Aspects of the present disclosure involve an innovative non-transitory computer readable medium, storing instructions for remote snapshot restoration. The instructions may include receiving a snapshot restore request from host cluster view; transferring the snapshot restore request to a global snapshot utilization module; determining, at the global snapshot utilization module, if the received snapshot restore request satisfies a three-way connection requirement; for the received snapshot restore requesting satisfying the three-way connection requirement, performing snapshot restoration by creating volume associated with the snapshot restore request as source volume in a first storage device; concurrently executing data copying from the source volume to a destination volume in a second storage device while enabling an application to access data stored in the source volume and the destination volume; triggering application deployment operation to enable an application to be deployed in a host cluster management module associated with the second storage device; and deleting the source volume when data copying from the source volume to a destination volume is completed.

Aspects of the present disclosure involve an innovative server system for remote snapshot restoration. The method may include receiving a snapshot restore request from host cluster view; transferring the snapshot restore request to a global snapshot utilization module; determining, at the global snapshot utilization module, if the received snapshot restore request satisfies a three-way connection requirement; for the received snapshot restore requesting satisfying the three-way connection requirement, performing snapshot restoration by creating volume associated with the snapshot restore request as source volume in a first storage device; concurrently executing data copying from the source volume to a destination volume in a second storage device while enabling an application to access data stored in the source volume and the destination volume; triggering application deployment operation to enable an application to be deployed in a host cluster management module associated with the second storage device; and deleting the source volume when data copying from the source volume to a destination volume is completed.

Aspects of the present disclosure involve an innovative system for remote snapshot restoration. The system may include means for receiving a snapshot restore request from host cluster view; transferring the snapshot restore request to a global snapshot utilization module; means for determining, at the global snapshot utilization module, if the received snapshot restore request satisfies a three-way connection requirement; for the received snapshot restore requesting satisfying the three-way connection requirement, means for performing snapshot restoration by creating volume associated with the snapshot restore request as source volume in a first storage device; means for concurrently executing data copying from the source volume to a destination volume in a second storage device while enabling an application to access data stored in the source volume and the destination volume; triggering application deployment operation to enable an application to be deployed in a host cluster management module associated with the second storage device; and means for deleting the source volume when data copying from the source volume to a destination volume is completed.

### BRIEF DESCRIPTION OF DRAWINGS

A general architecture that implements the various features of the disclosure will now be described with reference to the drawings. The drawings and the associated descriptions are provided to illustrate example implementations of the disclosure and not to limit the scope of the disclosure. Throughout the drawings, reference numbers are reused to indicate correspondence between referenced elements.

FIG. 1 illustrates an example conventional storage system.

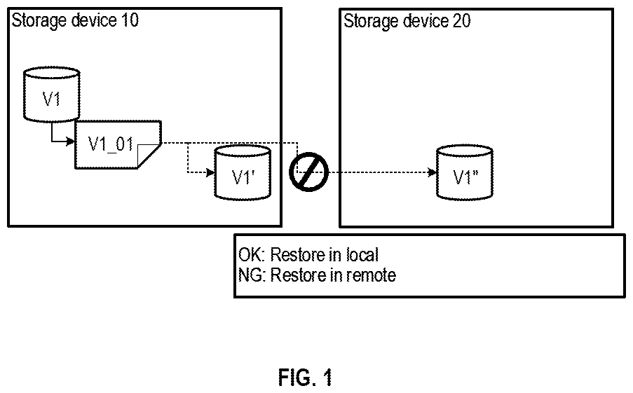

FIG. 2 illustrates an example system implementing remote snapshot restoration utilization, in accordance with an example implementation.

FIG. 3 illustrates an example process flow for concurrent execution of data copying and application access, in accordance with an example implementation.

FIG. 4 illustrates an example process flow of remote snapshot utilization, in accordance with an example implementation.

FIG. 5 illustrates example information and tables contained in the database 211 that are used in the remote snapshot restoration utilization process, in accordance with an example implementation.

FIG. 6 illustrates an example display of the snapshot restore view 241, in accordance with an example implementation.

FIG. 7 illustrates an example host-device-device connection table creation flow, in accordance with an example implementation.

FIG. 8 illustrates example information tables required for the connection table creation flow, in accordance with an example implementation.

FIG. 9 illustrates an example system implementing remote snapshot restoration utilization with cluster management, in accordance with an example implementation.

FIG. 10 illustrates an example process flow for snapshot list propagation, in accordance with an example implementation.

FIG. 11 illustrates an example process flow of remote snapshot utilization utilizing host cluster management systems, in accordance with an example implementation.

FIG. 12 illustrates example information required for performing snapshot utilization in host cluster management, in accordance with an example implementation.

FIG. 13 illustrates an example computing environment with an example computing device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm. Example implementations as described herein can be utilized either singularly or in combination, and the functionality of the example implementations can be implemented through any means according to the desired implementations.

Example implementations disclose the utilization of a remote snapshot utilization module that can select one or more hosts and two or more storage devices in which concurrent execution is guaranteed to run successfully. It can also command the selected host and the storage devices remotely to execute both the data copying and application access concurrently (concurrent execution).

Concurrent execution in remote snapshot utilization enables application to start using a volume as soon as it is restored from a snapshot, and the application no longer needs to wait until data copying finishes, so it is possible to eliminate wait time associated with the start of application. In addition, there is no need to proactively copy any data required for the remote snapshot restoration. Therefore, it can minimize storage consumption and reduce total cost incurred for storage infrastructure.

The initiation flow guarantees network connectivity among host and storage devices. This way, network failure in the remote snapshot restoration can be avoided. Example implementations can show wait time calculated from throughput or other factors. Example implementations also disclose a method to inform cluster management, such as Kubernetes, of usable snapshots and select appropriate destination storage device to restore the snapshots on behalf of cluster management.

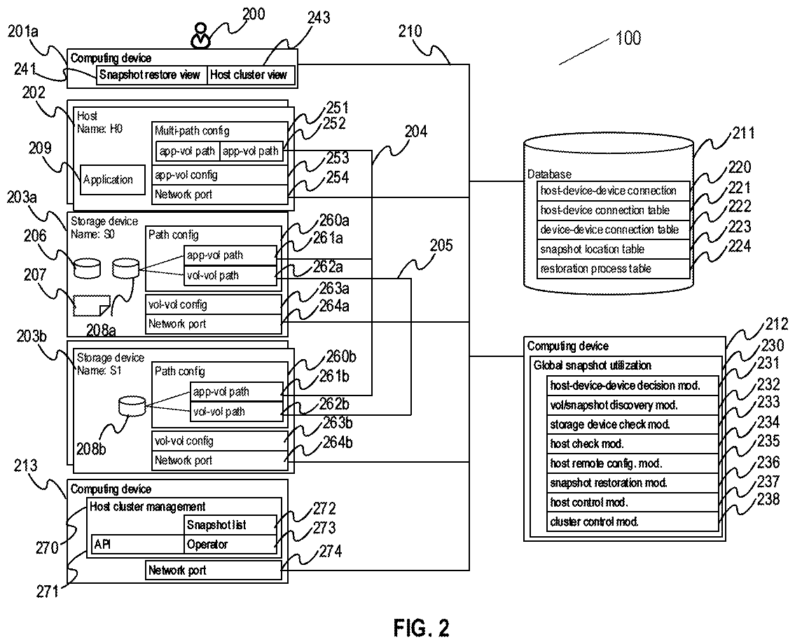

FIG. 2 illustrates an example system implementing remote snapshot restoration utilization, in accordance with an example implementation. Control of volume 206, snapshot 207, volumes 208a and 208b, and application 209 is needed to accomplish concurrent execution and the required initiation flow. The system 100 may include computing device 201a, host 202, storage devices 203a and 203b, computing network 204, storage area network 205, management network 210, database 211, and computing devices 212 and 213. More than a single host 202 may be involved in the system 100. These components can form part of a single data center or can be distributed across multiple data centers.

Computing network 204 connects host 202 with storage devices 203a and 203b. Storage area network 205 connects storage devices 203a and 203b, and is used specifically as volume-to-volume (vol-vol) path in data copying which will be described in more detail below. Management network 210 connects computing device 201a, host 202, storage devices 203a and 203b, database 211, and computing devices 212 and 213 in the system 100, and allows communication among all components required for initiation flow.

User 200 manages host 202 and storage devices 203a and 203b. There can be more than a single user 200 for work sharing or role separation. Computing device 201a shows snapshot restore view 241 or host cluster view 242 to user 200. Host 202 contains application 209, multi-path configuration 251, application-volume configuration (app-vol config) 253, and network port 254.

Storage devices 203a or 203b, labeled with respective name, each contains path configuration 260, volume-volume configuration (vol-vol config) 263, and network port 264. As illustrated in FIG. 2, storage device 203a has the name S0 which is used as ID in the initiation flow. On the other hand, storage device 203b has the name S1. These names are unique to devices. Path config 260 contains application-volume path (app-vol path) 261 and volume-volume path (vol-vol path) 262.

Database 211 may include host-device-device connection table 220, host-device connection table 221, device-device connection table 222, snapshot location list 223, and restoration process table 224.

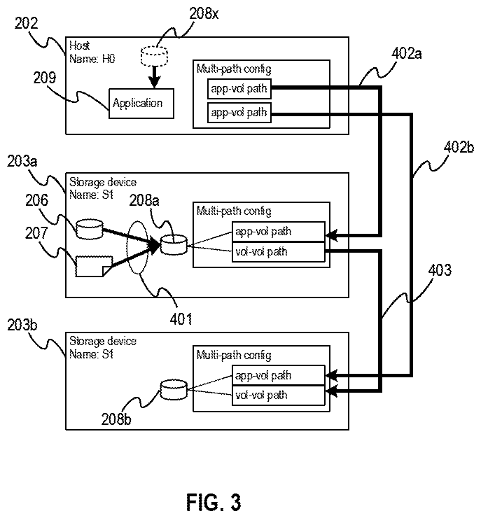

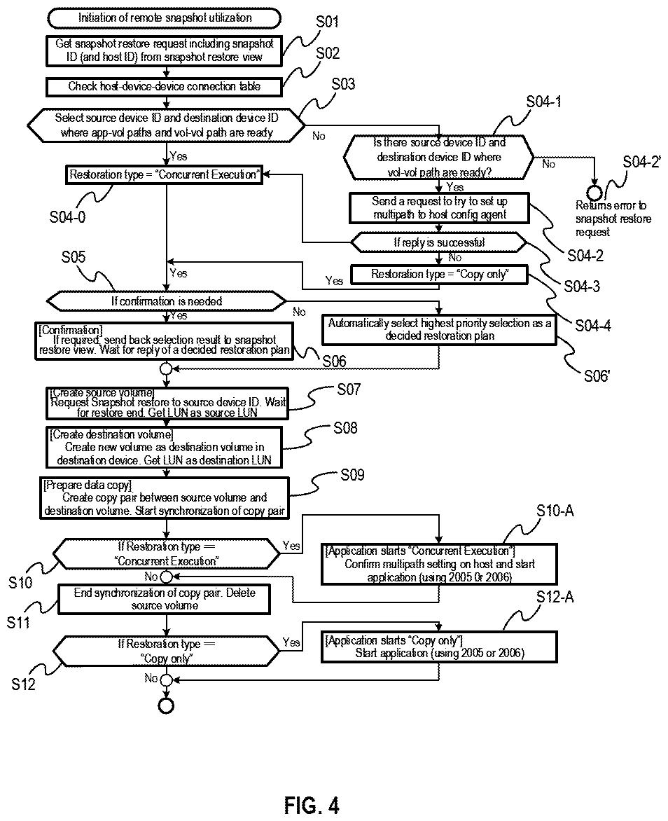

Computing device 212 may include global snapshot utilization 230. The global snapshot utilization has essential components for remote snapshot restoration process which is explained in FIGS. 3 and 4. The global snapshot utilization 230 contains host-device-device decision module 231, vol/snapshot discovery module 232, storage device check module 233, host check module 234, host remote config module 235, snapshot restoration module 236, host control module 237, and cluster control module 238.

Computing device 213 is used for host cluster management purpose by user 200. Host cluster management is a function to manage multiple hosts 202 and applications 209. Host cluster management 270 may include application programming interface (API) 271 which can be used by host cluster view 242, snapshot list 272, operator 273, and network port 274.

Concurrent execution of data copy and application access enables quick application start. Concurrent execution starts application access to volume before data copying across storage devices is completed. Upon completion of the data copying process, all application access is forwarded to the destination volume. At which point, the source volume is no longer needed and is automatically deleted.

FIG. 3 illustrates an example process flow for concurrent execution of a data copying and application access, in accordance with an example implementation. Concurrent execution is performed through a specified host and specified storage devices. Application 209 in host 202 reads and writes to a volume 208x.

A snapshot restoration process 401 restores the volume 208x from volume 206 and snapshot 207 in storage device 203a. The volume 208x is physically located in storage device 203a as volume 208a at the initial state.

The process then continues with concurrent execution of data copying and initiation of application access. Data copy execution runs in storage devices 203a and 203b. Following the data copying process, volume 208a begins to be copied to volume 208b in storage device 203b. Communication required for the data copy execution uses the vol-vol path 403, connecting storage devices 203a and 203b. On the other hand, application access is executed from application 209 to volumes 208a and 208b. Communication required for application access uses both paths 402a and 402b.

For concurrent execution, three-way paths among host and storage devices are needed. During concurrent execution, application continues reading and writing to volume 208x. Actual data locations of the volume 208x are distributed to volumes 208a and 208b. Therefore, application reads and writes to either of volumes 208a and 208b. After completion of data copying, application access is kept alive, but has only access to volume 208b as all data in volume 208x have already been copied to storage device 203b.

Three-way connections require two app-vol paths 252a and 252b in host 202 connecting with storage devices 203a and 203b respectively. Volume 208a is connected/communicates through app-vol path 252a. These configurations should be set up prior to occurrence of the concurrent execution. Otherwise, one of the processes will fail and the application would not be able to start using the restored volume.

To guarantee that concurrent execution is executed with no network failure, an initiation flow is executed prior to the concurrent execution by host-device-device decision module 231 and snapshot restoration module 236.

FIG. 4 illustrates an example process flow of remote snapshot utilization, in accordance with an example implementation. At step S01, the initiation of the process flow is triggered by a snapshot restore request from user 200 through the computing device 201a. At S02, the host-device-device decision module 231 checks the host-device-device connection table 220.

The host-device-device decision module 231 searches the host-device-device connection table 220 for a combination of host, source device, and destination device where app-vol paths and vol-vol path are ready at step S03. This means that the three-way connection required for concurrent execution can be established among the searched host, the selected source device, and the selected destination device. If a combination exists, then the process proceeds to step S04-0. Otherwise, the process continues to step S04-1.

At step S04-0, a flag named “Restoration type” is set to “Concurrent Execution”. At step S04-1, host-device-device decision module 231 tries to search for a combination of source device ID and destination device ID where vol-vol path is ready. If a combination exists, then the process continues to S04-2. Otherwise, the process continues to S04-2′, where the initiation flow comes to an end with error returned to original snapshot restore request.

At step S04-2, host check module 234 commands app-vol config module 253 to try and establish app-vol paths, and checks if app-vol path is established. Then, host check module 234 updates the host-device-device connection table 220. At step S04-3, a determination is made as to whether set-up or establishment is completed through receipt of a reply that corresponds to successful set-up. If successful, the process continues to S04-0, where the flag “Concurrent Execution” is set to “Copy only”. If unsuccessful, the process continues to S04-4, where the flag “Restoration type” is set to “Copy only”, which means that application using the snapshot could only start after data copying finishes.

At step S05, the host-device-device decision module 231 checks if the original requester (user) needs to provide confirmation. If confirmation is required, the process proceeds to step S06. Otherwise, the process continues to step S06′. At step S06, the host-device-device decision module 231 sends back selection result to snapshot restore view 241. The result may contain multiple restoration plans. After sending it, the host-device-device decision module 231 waits for the user's reply which includes a selected restoration plan. In this sequence, the user 200 uses snapshot restore view 241 to decide on a restoration plan, which is described in more details below.

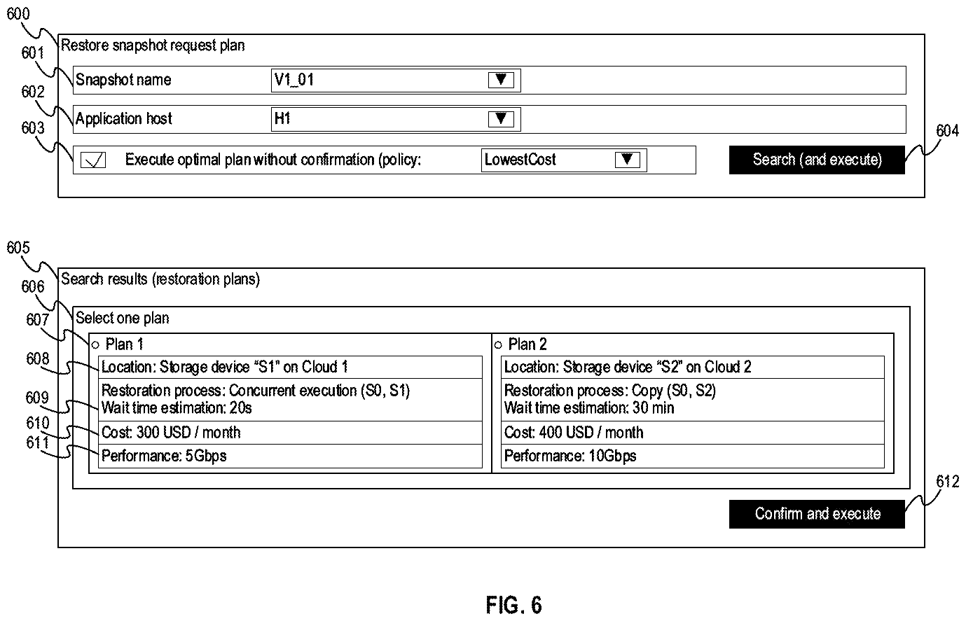

At step S06′, the host-device-device decision module 231 automatically selects a restoration plan having highest priority from among the multiple restoration plans of the result as the selected plan. For example, if the policy for automatic selection is associated with cost reduction, the host-device-device decision module 231 then selects a restoration plan with the lowest cost from all possible plans. After step S06 or step S06′, the module decides on a restoration plan, which is shown in FIG. 6.

At step S07, snapshot restoration module 236 requests snapshot restore on a source device with selected source device ID in restoration plan. Then, the snapshot restoration module 236 waits for restoration to be completed and receives LUN logical unit number (LUN) from the selected source device, which is used as source LUN.

At step S08, snapshot restoration module 236 creates a new volume as the destination volume in a destination device with the selected destination device ID. Snapshot restoration module 236 receives the resulting LUN as destination LUN.

At step S09, snapshot restoration module 236 prepares for data copying. Specifically, snapshot restoration module 236 creates copy pair between source volume and destination volume. After that, storage devices 203a and 203b begin synchronization of copy pair.

At step S10, if “Restoration type” is “Concurrent Execution”, then the process continues to S10-A. At step S10-A, snapshot restoration module 236 commands app-vol config module 253 to start application 209. In this step, app-vol config module 253 configures two app-vol paths 252 in multi-path config 251 so that it accesses source LUN and destination LUN. For example, it can use iscsiadm login command using source LUN and destination LUN as parameters. This allows for concurrent execution of data copying and application access.

At step S11, snapshot restoration module 236 receives an event of synchronization end of the copy pair. Then, the snapshot restoration module 236 deletes the source volume which is no longer needed by application 209.

At step S12, if “Restoration type” is “Copy only”, then the process continues to S12-A, where application 209 is started after data copying finishes. Through the steps of FIG. 4, initiation flow can achieve selection of restoration plan, preparation of data copying, and concurrent execution of data copying and application access.

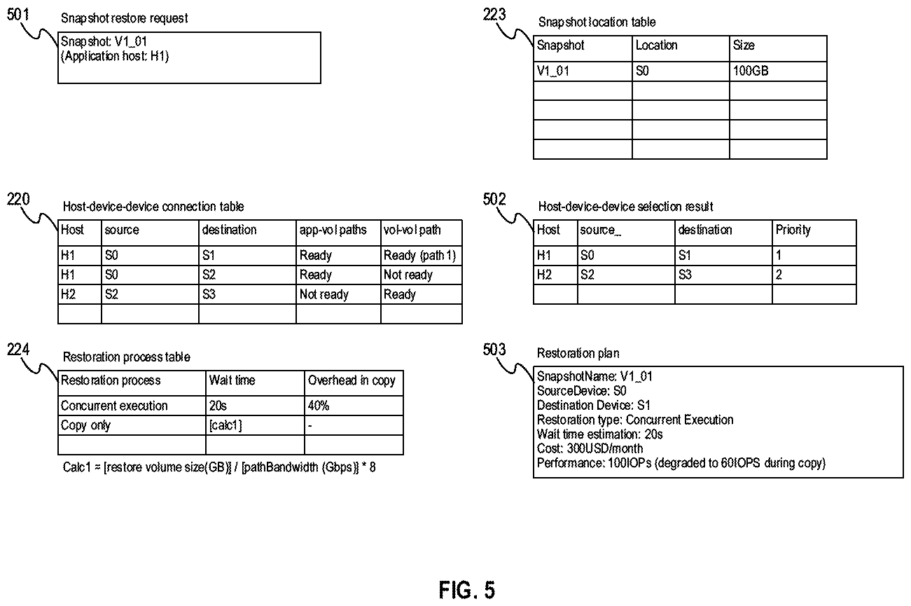

FIG. 5 illustrates example information and tables contained in the database 211 that are used in the remote snapshot restoration utilization process, in accordance with an example implementation. Snapshot restore request 501 triggers the initiation flow and received at step S01 of FIG. 4. Snapshot restore request 501 may include information such as, but not limited to, snapshot identifier and application host identifier. Snapshot location table 223 stores information of the location where snapshots are stored and is created under a snapshot creation process where snapshot creation request is initiated by the user 200. In some example implementations, the snapshot creation request may include at least one of target volume information and timestamp information. Snapshot location table 223 may include information such as, but not limited to, snapshot identifier, storage device location information, and size information. On receiving snapshot restore request 501, storage device location information of a specified snapshot identifier can be identified and retrieved. For example, the snapshot identifier “V1_01” is located at storage device S0 based on the snapshot location table 223.

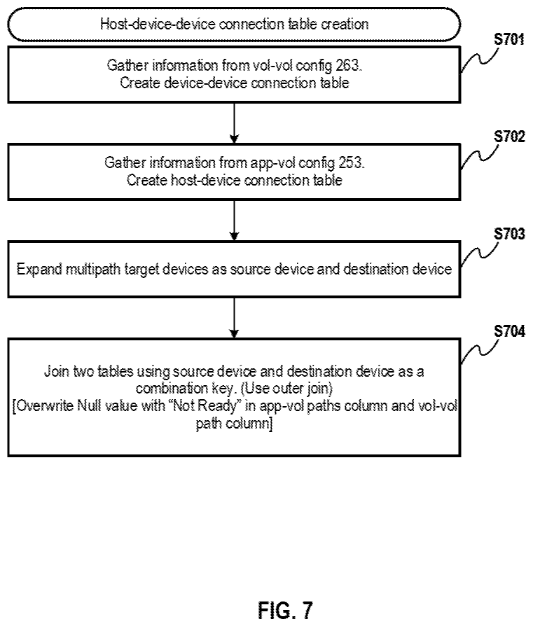

Host-device-device connection table 220 may include connection status information showing the three-way connections and is described in more detail below in association with FIG. 7. As mentioned, three-way connection is needed for concurrent execution. To ensure the three-way connection can be established, host-device-device connection table 220 contains both columns of app-vol paths and vol-vol paths. Host-device-device connection table 220 contains information such as, but not limited to, host name, source, destination, app-vol paths, and vol-vol path. The host name column stores host name identifiers. Source column stores unique ID values for source storage devices. Destination column stores unique ID values for destination storage devices. App-vol paths store Boolean values such as “Ready” and “Not Ready” to indicate whether app-vol paths can be established among the combination of host-device-device. Similarly, vol-vol path stores Boolean values such as “Ready” and “Not Ready” to indicate whether both storage devices can be connected with the specified vol-vol path.

Host-device-device selection result 502 is created temporarily by initiation flow. The host-device-device selection result 502 is created during step S03 of FIG. 4 This table may include information such as, but not limited to, host name, source device, destination device, and priority column. Each entry in the host-device-device selection result 502 is associated with a combination of host, source device, and destination device of the host-device-device connection table 220. Priority column stores priority levels associated with the combination of host, source, and destination. In some example implementations, the priority levels may be set by the user 200. For example, high priority may be assigned with the value 1 (e.g. for concurrent execution), while the value 2 indicates lower priority.

Restoration process table 224 is used for calculation of the wait time associated with each restoration plan and is manually created by the user 200. Restoration process table 224 may include information such as, but not limited to, restoration process name, wait time, and overhead in copying. Restoration process name stores unique process identifiers associated with the different restoration processes.

Restoration plan 503 is created at steps S06 and S06′ of the initiation flow and sent to snapshot restore view 241. Restoration plan 503 stores information such as, but not limited to, snapshot name, source device, destination device, restoration type, wait time estimation, cost estimation, and performance estimation. Snapshot name, source device, and destination device are populated from the host-device-device selection result 502. Restoration type is a value of flag “Restoration type” that is set during steps S04-0 to S04-4 of the initiation flow illustrated in FIG. 4. Wait time estimation is obtained from the wait time associated with restoration process from the restoration process table 224. For example, if restoration type is “Concurrent Execution”, wait time is then estimated to be “20 s” as shown in the restoration process table 224. In some example implementations, wait time may be calculated using predetermined formula identified in the restoration process table 224. For example, if restoration type is “Copy only”, wait time is calculated using the formula “[calc1]”. Calc1 is defined as “[restored volume size (GB)]/[PathBandwidth(Gbps)]*8”. If the snapshot has 100 GB size and the path bandwidth is 5 Gbps, the calculated result becomes 160 s.

Cost estimation and performance estimation can be obtained from the cloud vendor spec sheet. Each instance type used by storage device has various cataloged specification. As illustrated in FIG. 5, cost estimation as provided from the spec sheet is 300 USD/month. Similarly, performance value from the spec sheet, such as “1IOPS per GB”, can be used to calculate the value “100IOPS” for performance estimation.

FIG. 6 illustrates an example display of the snapshot restore view 241, in accordance with an example implementation. As illustrated in the initiation flow of FIG. 4, snapshot restore view 241 is used to retrieve the snapshot restore request from user 200, show results from the initiation flow, and retrieve user's confirmation.

Snapshot restore view 241 contains restore snapshot request plan 600 for user 200 to create a snapshot restore request and search results for user 200's request. The restore snapshot request plan 600 may include input areas such as snapshot name 601, application host 602, confirmation requirement toggle 603, and search button 604. By accessing the snapshot name 601 and the application host 602, user 200 can decide which snapshot to restore, and which application host to use for restoring volume access in the restore snapshot request plan 600. Through the confirmation requirement toggle 603, user 200 can specify whether user 200 needs to review search result of possible restoration plans. If the toggle is off, step S05 of the initiation flow as illustrated in FIG. 4 then proceeds to step S06′, where the system automatically selects a highest priority selection as restoration plan. Clicking the search button 604 allows for restore plan search to be performed based on user selections.

Search results 605 appears after search button 604 has been clicked. Search results 605 may include display areas, including plan selection 606. Plan selection 606 contains one or more plans calculated from the initiation flow. For example, plan selection 606 as illustrated in FIG. 6 provides two plans 607, plan 1 and plan 2. Each selectable plan 607 may include selection radio button, location information 608, restoration process 609, cost estimation 610, and performance estimation 611. Location information 608 identifies a destination device for use as destination device of copy pair. Restoration process 609 identifies the type of restoration process that will be used in the plan. In addition, estimated wait time is also provided as part of restoration process 609. “Concurrent execution” type restoration process means that concurrent execution will be utilized. On the other hand, “Copy” type restoration process means that sequential copying will be used, which has a longer wait time when compared to “Concurrent execution”.

Cost estimation 610 provides user with information on location-dependent cost. For example, plan 1 uses storage device “S1” in Cloud 1 as destination storage device and has an estimated cost of 300 USD/month. Performance estimation 611 provides user with information on location-dependent performance indicator. For example, destination storage device “S1” bas an expected throughput of 5 Gbps, and performance 611 of plan 1 shows “5 Gbps”.

Confirmation button 612 is a button which user 200 can click should user 200 accept one of the plans. Confirmation button 612 becomes clickable when user 200 selects any of plans by radio button. On submission, the selected plan is sent to the host-device-device decision module 231, which corresponds to step S06 of FIG. 4.

As illustrated in FIGS. 2 and 5, the host-device-device connection table 220 is used for location determination and is updated iteratively by a connection table creation flow. FIG. 7 illustrates an example host-device-device connection table 220 creation flow, in accordance with an example implementation. The storage device check module 233 and host check module 234 run the connection table creation flow repetitively. The flow can be repeated at the same cycle or can be run ad-hoc by some events such as, but not limited to, device addition, device deletion, etc.

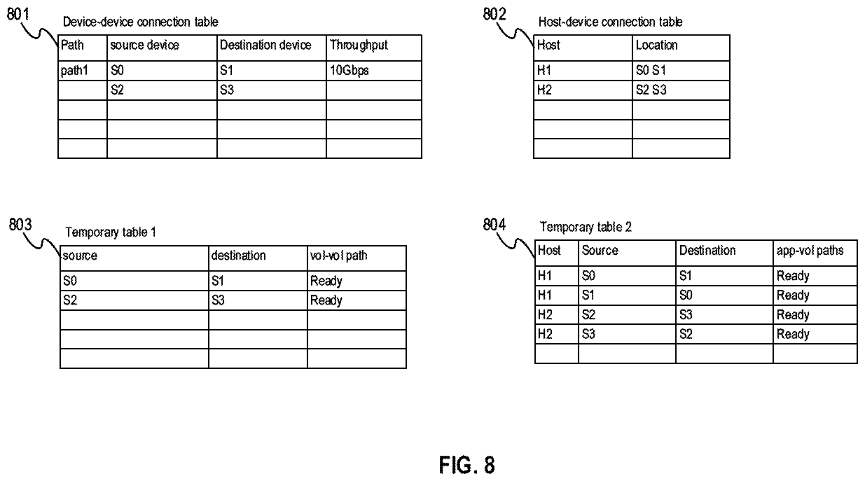

At step S701, information is gathered from the vol-vol config 263 to create the device-device connection table 801 of FIG. 8. FIG. 8 illustrates example information tables required for the connection table creation flow, in accordance with an example implementation. Device-device connection table 801 is generated by step S701 of FIG. 7, and may include fields such as, but not limited to, path, source device, destination device, and throughput.

The device-device connection table 801 can be simplified into temporary table 803, which may include fields such as source device, destination device, and vol-vol path. As illustrated in FIG. 8, the vol-vol path field is added and values in the field is set to “Ready” by default in the temporary table 803.

The host-device connection table 802 is generated by step S702 of FIG. 7, and may include fields such as, but not limited to, host, multipath target devices, etc. At step S702, information is gathered from app-vol config 253 to create the host-device connection table 802. In step S703, the host-device connection table 802 can be expanded into temporary table 804 by expanding multipath target devices as source device and destination device. The temporary table 804 may include fields such as, but not limited to, host, source device, destination device, app-vol paths, etc. As illustrated in FIG. 8, the app-vol path field is added and values in the field is set to “Ready” by default. At step S704 of FIG. 7, temporary table 803 and temporary table 804 are joined using source device and destination device as combination keys to create the host-device-device connection table 220. In some example implementation, joining is performed using the OUTER JOIN method of SQL. Any entry that does not have an associated value in the app-vol paths field or the vol-vol path field would have “Not Ready” in place as the associated value. On completion of the preceding steps, the host-device-device connection table 220 is then generated.

In alternate example implementations, host cluster management tools such as Kubernetes are used to execute remote snapshot utilization on behalf of user request in conjunction with a global snapshot utilization module. Utilization of host cluster management system such as Kubernetes makes user's host/device management operation easier. In order to enable snapshot utilization in host cluster management, snapshot list propagation and snapshot utilization are utilized. Associated flows are described in more details below. Unlike the system shown in FIG. 2, a user does not need to use dedicated view such as the snapshot restore view 241, as only host cluster management is needed. Operator is added to existing host cluster management to facilitate communications with the global snapshot utilization module.

Host cluster management can deploy application on hosts and allows the application to access a volume pair being restored by concurrent execution without specific storage device interaction. Host cluster management does not need to have information of which snapshots are available, or what type of data copy is ongoing in storage device side. Instead, global snapshot utilization takes care of snapshot listing and the status of data copying.

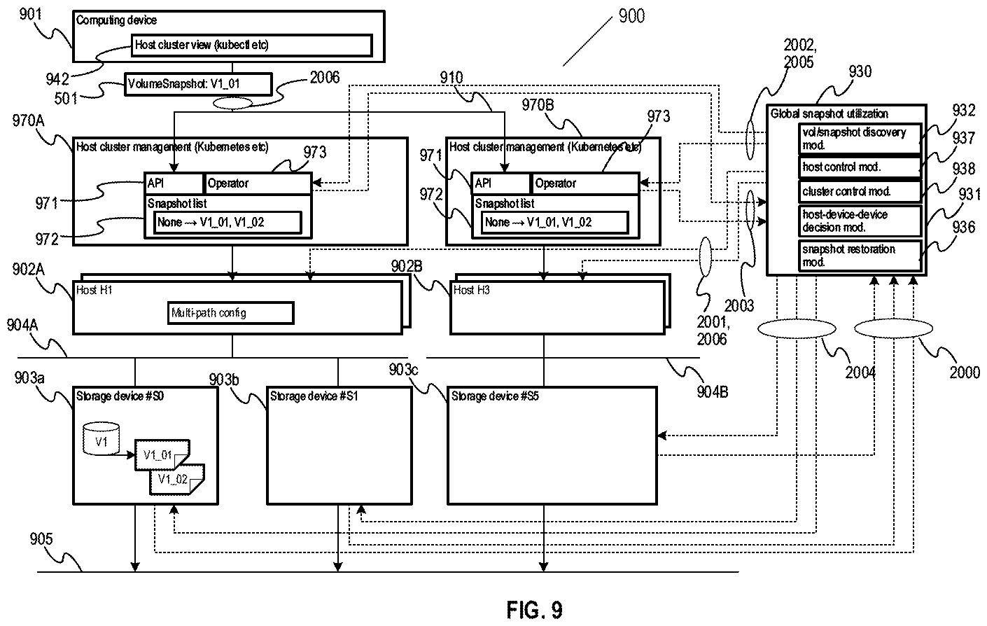

FIG. 9 illustrates an example system implementing remote snapshot restoration utilization with cluster management, in accordance with an example implementation. As illustrated in FIG. 9, system 900 may include computing device 901, hosts 902A and 902B, storage devices 903a-903c, computing network 904, storage area network 905, management network 910, database 911, global snapshot utilization module 930, and host cluster management systems 970A and 970B. The system of FIG. 9 shares many of the components of the system in FIG. 2. However, user of FIG. 9 uses host cluster view 942 rather than the snapshot restore view 241 of FIG. 2. Host cluster view 942 is any client tool of host cluster management system, such as Kubernetes, etc. In some example implementations, the client tool is a CLI tool kubectl.

User can use commands supported by host cluster management system 970A or 970B using host cluster view 942. For example, “kubectl create pve” command is for volume creation in some storage device, and user can specify how the volume is to be created. User can also add parameters such as “snapshotName” so that a volume can be created from snapshot. By so doing, user can request snapshot utilization to host cluster management system 970A or 970B without specifying which storage device to be used as snapshot restoration destination. The global snapshot utilization 930 automatically decides which storage device to be used for snapshot utilization.

Host cluster management systems 970A and 970B execute host/device management operations including application deployment and snapshot utilization. Host cluster management systems 970A and 970B command these operations to hosts 902A and 902B on behalf of the user. Host cluster management systems 970A and 970B connect to hosts 902A and 902B respectively, and control hosts 902A and 902B according to user's request 501. Each of host cluster management systems 970A and 970B is capable of controlling multiple hosts at the same time. Operator 973 in host cluster management systems 970A-B monitors incoming user requests and forwards them to the global snapshot utilization module 930.

Host 902A is controlled by host cluster management system 970A, while host 902B is controlled by host cluster management system 970B. Hosts 902A and 902B are connected respectively to computing network 904A and 904B. Storage devices 903a and 903b are connected to computing network 904A, and storage device 903c is connected to computing network 904B.

Communication 2000 is transmitted from storage devices 903a-c to global snapshot utilization module 930, and vice versa, communication 2004 is transmitted from global snapshot utilization module 930 to storage devices 903a-c. Communications 2001 and 2006 are transmitted from global snapshot utilization module 930 to hosts 902A-B. Communications 2002 and 2005 are transmitted from global snapshot utilization module 930 to operator 973 in host cluster management systems 970A-B and vice versa, communication 2003 is transmitted from operator 973 to global snapshot utilization module 930.

Host cluster management systems 970A-B do not have the ability to get list of snapshots from storage devices 903a-c because host cluster management systems 970A-B are not in direct connection with storage devices 903a-c. This causes an issue when a snapshot is restored. When user requests volume creation from snapshot, host cluster management systems 970A-B cannot accept the request because they cannot check the specified snapshot in the snapshot list.

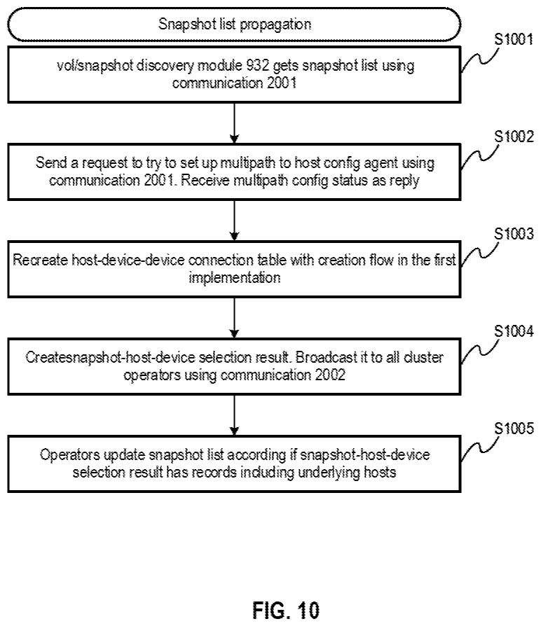

FIG. 10 illustrates an example process flow for snapshot list propagation, in accordance with an example implementation. Snapshot list propagation allows host cluster management systems 970A-B to accept user request according to snapshot list sent from global snapshot utilization module 930.

Vol/snapshot discovery module 932 of the global snapshot utilization module 930 triggers the entire flow. The module gets snapshot list using communication 2001 of FIG. 9 from storage devices. To achieve this, global snapshot utilization module 930 uses management network 910 to connect to the storage devices. At step S1001, the vol/snapshot discovery module 932 requests snapshot list API in storage devices and merges all snapshot lists into a single list.

At step S1002, the host-device-device decision module 931 sends a request to all hosts to try to set up multipath config agent using communication 2001. In return, the host-device-device decision module 931 receives multipath config status as reply. If the status is true, the module updates related record in host-device-device connection table 220 so that the host's multipath is ready.

At step S1003, host-device-device decision module 931 recreates host-device-device connection table 220 with table creation flow in the first implementation.

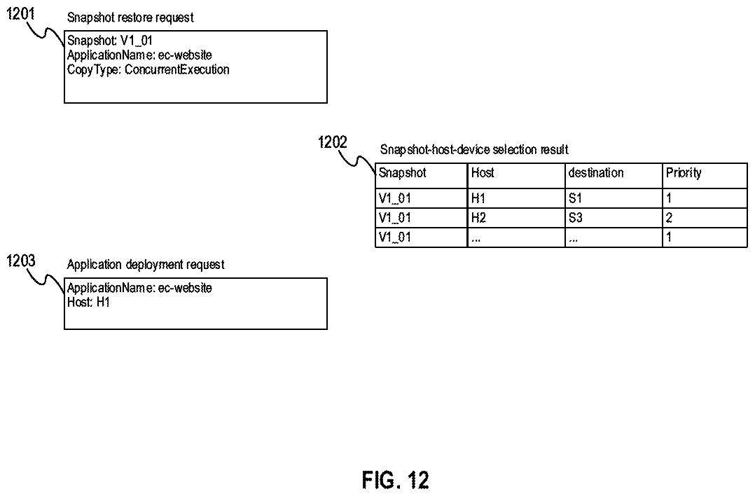

At step S1004 host-device-device decision module 931 joins snapshot location table 223 with host-device-device connection table 220 and creates snapshot-host-device selection result, which is described in more details in FIG. 12.

At step S1005, operators 973 of all hosts receive the snapshot-host-device selection result and update snapshot list according to the selection result. If the selection result has records of the host name, the snapshot list adds the snapshot name into the record. For example, suppose snapshot-host-device selection result has records of “snapshot: V1_01”, “host: H1” and “device: S0”, and the result is received by the operator 973 in host “H1”. Then, operator 973 checks the result record including “host: H1”. Since the result is true, the operator 973 adds snapshot “V1_01” to the snapshot list.

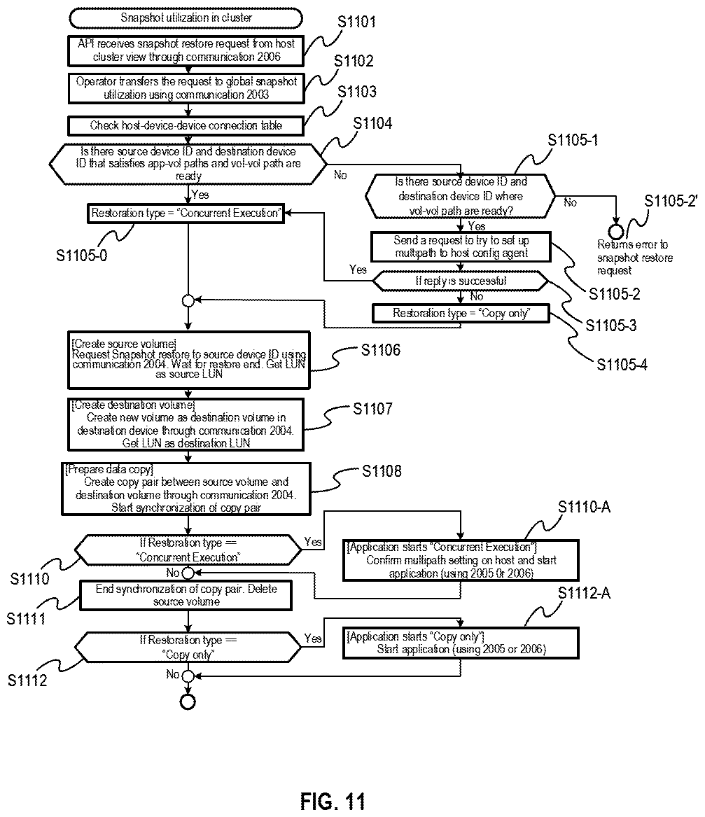

FIG. 11 illustrates an example process flow of remote snapshot utilization utilizing host cluster management systems, in accordance with an example implementation. Snapshot utilization flow is triggered at step S1101 when API 971 of FIG. 9 receives snapshot restore request from host cluster view through communication 2006. At step S1102, operator transfers the request to global snapshot utilization using communication 2003. Steps S1103-1112 of the process flow perform similar functions to steps S02-12 of FIG. 4, with differences at steps S1110-A and S1112-A. The difference is that in step S1110-A or S1112-A, “application start” will return to operators who originally initiated this flow. The “application start” message triggers application deployment operation in host cluster management. For example, Kubernetes can start application deployment with registering a new resource “Application deployment request”. According to this change, host cluster management starts application container in a specific host. During this timing, host cluster management can use the host name generated during step S1105.

FIG. 12 illustrates an example information required for performing snapshot utilization in host cluster management, in accordance with an example implementation. As illustrated in FIG. 12, example information may include a snapshot restore request 1201, a snapshot-host-device selection result table 1202, and an application deployment request 1203. The snapshot restore request 1201 is a trigger event of snapshot utilization at step S1101 of FIG. 11. Snapshot-host-device selection result 1202 is generated during step S1104 of FIG. 11. Snapshot-host-device selection result 1202 may include information such as, but not limited to, snapshot name, host, destination, and associated priority level. Application deployment request 1203 contains information such as application name and host to be used by the application. The format of application deployment request changes depending on figurations of the host cluster management systems.

Through the present implementation, the host cluster management can forward snapshot restoration request to the global snapshot restoration module and initiate concurrent execution. In addition, through generation of snapshot list from snapshot list propagation, host cluster management can accept snapshot restore request when snapshot name is on the snapshot list.

The foregoing example implementation may have various benefits and advantages. For example, remote snapshot utilization can be executed without any knowledge about hosts, devices and connections. Using concurrent execution in remote snapshot utilization, user's application can start using a volume as soon as it is restored from a snapshot. At the same time, concurrent execution enables application to start before data copy finishes. There is no need to proactively copy any data required for the remote snapshot restoration. Therefore, storage consumption is minimized and total cost paid for storage infrastructure is reduced. Furthermore, the initiation flow guarantees network connectivity among host and storage devices, such that network failure in the remote snapshot restoration can be avoided. Users can start remote snapshot utilization through host cluster management and benefit from quickness and cost reduction of remote snapshot utilization.

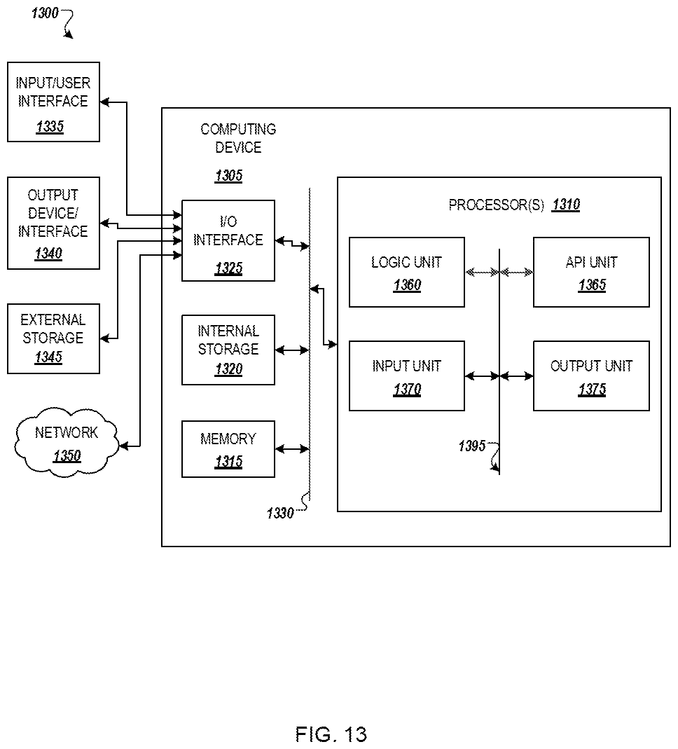

FIG. 13 illustrates an example computing environment with an example computing device suitable for use in some example implementations. Computing device 1305 in computing environment 1300 can include one or more processing units, cores, or processor(s) 1310, memory 1315 (e.g., RAM, ROM, and/or the like), internal storage 1320 (e.g., magnetic, optical, solid-state storage, and/or organic), and/or I/O interface 1325, any of which can be coupled on a communication mechanism or bus 1330 for communicating information or embedded in computing device 1305. I/O interface 1325 is also configured to receive images from cameras or provide images to projectors or displays, depending on the desired implementation.

Computing device 1305 can be communicatively coupled to input/user interface 1335 and output device/interface 1340. Either one or both of the input/user interface 1335 and output device/interface 1340 can be a wired or wireless interface and can be detachable. Input/user interface 1335 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 1340 may include a display, television, monitor, printer, speaker, braille, or the like. In some example implementations, input/user interface 1335 and output device/interface 1340 can be embedded with or physically coupled to computing device 1305. In other example implementations, other computing devices may function as or provide the functions of input/user interface 1335 and output device/interface 1340 for a computing device 1305.

Examples of computing device 1305 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computing device 1305 can be communicatively coupled (e.g., via I/O interface 1325) to external storage 1345 and network 1350 for communicating with any number of networked components, devices, and systems, including one or more computing devices of the same or different configuration. Computing device 1305 or any connected computing device can be functioning as, providing services of, or referred to as, a server, client, thin server, general machine, special-purpose machine, or another label.

I/O interface 1325 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1300. Network 1350 can be any network or combination of networks (e.g., the Internet, local area network, wide area network, a telephonic network, a cellular network, satellite network, and the like).

Computing device 1305 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computing device 1305 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C #, Java, Visual Basic, Python, Perl, JavaScript, and others).

Processor(s) 1310 can execute under any operating system (OS) (not shown), in a native or virtual environment. One or more applications can be deployed that include logic unit 1360, application programming interface (API) unit 1365, input unit 1370, output unit 1375, and inter-unit communication mechanism 1395 for the different units to communicate with each other, with the OS, and with other applications (not shown). The described units and elements can be varied in design, function, configuration, or implementation and are not limited to the descriptions provided. Processor(s) 1310 can be in the form of hardware processors such as central processing units (CPUs) or in a combination of hardware and software units.

In some example implementations, when information or an execution instruction is received by API unit 1365, it may be communicated to one or more other units (e.g., logic unit 1360, input unit 1370, output unit 1375). In some instances, logic unit 1360 may be configured to control the information flow among the units and direct the services provided by API unit 1365, input unit 1370, and output unit 1375 in some example implementations described above. For example, the flow of one or more processes or implementations may be controlled by logic unit 1360 alone or in conjunction with API unit 1365. Input unit 1370 may be configured to obtain input for the calculations described in the example implementations, and output unit 1375 may be configured to provide an output based on the calculations described in example implementations.

Processor(s) 1310 can be configured to receive snapshot restore request as shown in FIG. 4. The processor(s) 1310 may also be configured to determine if the received snapshot restore request satisfies a three-way connection requirement by determining if the received snapshot restore request satisfies host-device-device connection information, wherein the host-device-device connection information comprises host information, source storage device information, destination storage device information, application-volume path information, and volume-volume path information as shown in FIG. 4. The processor(s) 1310 may also be configured to, for the received snapshot restore requesting satisfying the three-way connection requirement, perform snapshot restoration and data copying as shown in FIG. 4.

The processor(s) 1310 may also be configured to access, by the application, only data stored in the destination volume after completion of the data copying as shown in FIG. 4. The processor(s) 1310 may also be configured to determine if user confirmation is required in snapshot restoration plan selection as shown in FIG. 4. The processor(s) 1310 may also be configured to, for determining user confirmation is required in snapshot restoration plan selection, send at least one snapshot restoration plan for user to select as shown in FIG. 4.

The processor(s) 1310 may also be configured to, for determining user confirmation is not required in the snapshot restoration plan selection, perform automatic snapshot restoration plan selection by selecting a snapshot restoration plan having a highest priority from a plurality of snapshot restoration plans or selecting a recommended snapshot restoration plan from the plurality of snapshot restoration plans as shown in FIG. 4. The processor(s) 1310 may also be configured to, for the received snapshot restore request satisfying the three-way connection requirement, set restoration type to concurrent execution as shown in FIG. 4.

The processor(s) 1310 may also be configured to, for the received snapshot restore request not satisfying the three-way connection requirement, search for a combination of source device ID and destination device ID where volume-volume path is ready as shown in FIG. 4. The processor(s) 1310 may also be configured to, for existence of no combination of source device ID and destination device ID where volume-volume path is ready, return an error message to the snapshot restore request as shown in FIG. 4. The processor(s) 1310 may also be configured to, for existence of a combination of source device ID and destination device ID where volume-volume path is ready, attempt to establish application-volume paths as shown in FIG. 4. The processor(s) 1310 may also be configured to, for application-volume paths being successfully established, set restoration type to concurrent execution as shown in FIG. 4. The processor(s) 1310 may also be configured to, for application-volume paths being unestablished, set restoration type to copy only as shown in FIG. 4. The processor(s) 1310 may also be configured to, for restoration type being set to copy only, execute data copying from the source volume to the destination volume and only allow the application access data stored in the destination volume after completion of the data copying as shown in FIG. 4.

The processor(s) 1310 may also be configured to receive snapshot restore request from host cluster view as shown in FIGS. 9 and 11. The processor(s) 1310 may also be configured to transfer the snapshot restore request to a global snapshot utilization module as shown in FIGS. 9 and 11. The processor(s) 1310 may also be configured to determine, at the global snapshot utilization module, if the received snapshot restore request satisfies a three-way connection requirement as shown in FIGS. 9 and 11. The processor(s) 1310 may also be configured to, for the received snapshot restore requesting satisfying the three-way connection requirement, perform snapshot restoration by creating volume associated with the snapshot restore request as source volume in a first storage device as shown in FIGS. 9 and 11. The processor(s) 1310 may also be configured to concurrently execute data copying from the source volume to a destination volume in a second storage device while enabling an application to access data stored in the source volume and the destination volume as shown in FIGS. 9 and 11. The processor(s) 1310 may also be configured to trigger application deployment operation to enable an application to be deployed in a host cluster management module associated with the second storage device as shown in FIGS. 9 and 11. The processor(s) 1310 may also be configured to delete the source volume when data copying from the source volume to a destination volume is completed as shown in FIGS. 9 and 11.

The processor(s) 1310 may also be configured to access, by the application, only data stored in the destination volume after completion of the data copying as shown in FIG. 11. The processor(s) 1310 may also be configured to, for the received snapshot restore requesting satisfying the three-way connection requirement, set restoration type to concurrent execution as shown in FIG. 11.

The processor(s) 1310 may also be configured to, for the received snapshot restore requesting not satisfying the three-way connection requirement, search for a combination of source device ID and destination device ID where volume-volume path is ready as shown in FIG. 11. The processor(s) 1310 may also be configured to, for existence of no combination of source device ID and destination device ID where volume-volume path is ready, return an error message to the snapshot restore request as shown in FIG. 11. The processor(s) 1310 may also be configured to, for existence of a combination of source device ID and destination device ID where volume-volume path is ready, attempt to establish application-volume paths as shown in FIG. 11. The processor(s) 1310 may also be configured to, for application-volume paths being successfully established, set restoration type to concurrent execution as shown in FIG. 11. The processor(s) 1310 may also be configured to, for application-volume paths being unestablished, set restoration type to copy only as shown in FIG. 11. The processor(s) 1310 may also be configured to, for restoration type being set to copy only, execute the data copying from the source volume to the destination volume and only allow the application access data stored in the destination volume after completion of the data copying as shown in FIG. 11.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible medium such as, but not limited to, optical disks, magnetic disks, read-only memories, random access memories, solid-state devices and drives, or any other types of tangible or non-transitory media suitable for storing electronic information. A computer readable signal medium may include medium such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or they may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored in the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for remote snapshot restoration, the method comprising:
receiving a snapshot restore request;
determining if the received snapshot restore request satisfies a three-way connection requirement by determining if the received snapshot restore request satisfies host-device-device connection information, wherein the host-device-device connection information comprises host information, source storage device information, destination storage device information, application-volume path information, and volume-volume path information; and
for the received snapshot restore requesting satisfying the three-way connection requirement, performing snapshot restoration and data copying.

2. The method of claim 1, wherein the performing snapshot restoration and data copying comprises:
for the received snapshot restore request satisfying the three-way connection requirement, performing snapshot restoration by creating a volume associated with the snapshot restore request as a source volume in a first storage device;
concurrently executing data copying from the source volume to a destination volume in a second storage device while enabling an application to access data stored in the source volume and the destination volume; and
deleting the source volume when the data copying from the source volume to the destination volume is completed.

3. The method of claim 2, further comprising:
accessing, by the application, only data stored in the destination volume after completion of the data copying,
wherein the concurrently executing the data copying from the source volume to the destination volume while enabling the application to access data stored in the source volume and the destination volume enables the application to use the data stored in the source volume and the destination volume without waiting for the data copying to finish.

4. The method of claim 1, wherein the host-device-device connection information is generated by:
receiving volume-volume configuration information to create device-device connection information;
generating a source-destination volume path information by retrieving source information and destination information from the device-device connection information, and adding volume-volume path information;
receiving application-volume configuration information to create host-device connection information, the host-device-device connection information comprises host information and multipath target devices information;
generating an expanded host-device connection information by expanding multipath target devices information into source device information and destination device information, and adding application-volume path information; and
generation the host-device-device connection information by merging the source-destination volume path information with the expanded host-device connection information.

5. The method of claim 1, further comprising:
determining if a user confirmation is required in a snapshot restoration plan selection; and
for determining that the user confirmation is required in the snapshot restoration plan selection, sending at least one snapshot restoration plan for the user to select.

6. The method of claim 5, further comprising:
for determining that the user confirmation is not required in the snapshot restoration plan selection, performing automatic snapshot restoration plan selection by selecting one of a plurality of snapshot restoration plans having a highest priority or selecting a recommended one of the plurality of snapshot restoration plans.

7. The method of claim 5, wherein the sending the at least one snapshot restoration plan for the user to select comprises presenting the at least one snapshot restoration plan on a user interface (UI) for the user to select and confirm.

8. The method of claim 1, wherein the snapshot restore request comprises a snapshot ID and a host ID.

9. The method of claim 2, further comprising:
for the received snapshot restore request satisfying the three-way connection requirement, setting a restoration type to concurrent execution.

10. The method of claim 9, further comprising:
for the received snapshot restore request not satisfying the three-way connection requirement, searching for a combination of source device ID and destination device ID where volume-volume path is ready;
for existence of no combination of source device ID and destination device ID where volume-volume path is ready, returning an error message to the snapshot restore request;
for existence of a combination of source device ID and destination device ID where volume-volume path is ready, attempting to establish application-volume paths;
for the application-volume paths being successfully established, setting the restoration type to concurrent execution; and
for application-volume paths not being established, setting the restoration type to copy only.

11. The method of claim 10, wherein the concurrently executing data copying from the source volume to the destination volume in the second storage device while enabling the application to access data stored in the source volume and the destination volume is performed when the restoration type is the concurrent execution.

12. The method of claim 11, further comprising:
for the restoration type being set to copy only, executing data copying from the source volume to the destination volume and only allowing the application access to data stored in the destination volume after completion of the data copying.

13. A method for remote snapshot restoration, the method comprising:
receiving a snapshot restore request from host cluster view;
transferring the snapshot restore request to a global snapshot utilization module;
determining, at the global snapshot utilization module, if the received snapshot restore request satisfies a three-way connection requirement;
for the received snapshot restore request satisfying the three-way connection requirement, performing snapshot restoration by creating a volume associated with the snapshot restore request as a source volume in a first storage device;
concurrently executing data copying from the source volume to a destination volume in a second storage device while enabling an application to access data stored in the source volume and the destination volume;
triggering application deployment operation to enable an application to be deployed in a host cluster management module associated with the second storage device; and
deleting the source volume when data copying from the source volume to a destination volume is completed.

14. The method of claim 13, wherein the determining if the received snapshot restore request satisfies the three-way connection requirement comprises:
determining if the received snapshot restore request satisfies host-device-device connection information, wherein the host-device-device connection information comprises host information, source storage device information, destination storage device information, application-volume path information, and volume-volume path information.

15. The method of claim 14, wherein the host-device-device connection information is generated by:
receiving volume-volume configuration information to create device-device connection information;
generating a source-destination volume path information by retrieving source information and destination information from the device-device connection information, and adding volume-volume path information;
receiving application-volume configuration information to create host-device connection information, the host-device-device connection information comprises host information and multipath target devices information;
generating an expanded host-device connection information by expanding multipath target devices information into source device information and destination device information, and adding application-volume path information; and
generation the host-device-device connection information by merging the source-destination volume path information with the expanded host-device connection information.

16. The method of claim 13, further comprising:
accessing, by the application, only data stored in the destination volume after completion of the data copying,
wherein the concurrently executing the data copying from the source volume to the destination volume while enabling the application to access data stored in the source volume and the destination volume enables the application to use the data stored in the source volume and the destination volume without waiting for the data copying to finish.

17. The method of claim 13, further comprising:
for the received snapshot restore requesting satisfying the three-way connection requirement, setting restoration type to concurrent execution.

18. The method of claim 17, further comprising:
for the received snapshot restore requesting not satisfying the three-way connection requirement, searching for a combination of source device ID and destination device ID where volume-volume path is ready;
for existence of no combination of source device ID and destination device ID where volume-volume path is ready, returning an error message to the snapshot restore request;
for existence of a combination of source device ID and destination device ID where volume-volume path is ready, attempting to establish application-volume paths;
for the application-volume paths being successfully established, setting the restoration type to concurrent execution; and
for application-volume paths not being established, setting the restoration type to copy only.

19. The method of claim 18, wherein the concurrently executing data copying from the source volume to the destination volume in the second storage device while enabling the application to access data stored in the source volume and the destination volume is performed when the restoration type is the concurrent execution.

20. The method of claim 19, further comprising:
for the restoration type being set to copy only, executing the data copying from the source volume to the destination volume and only allowing the application access to data stored in the destination volume after completion of the data copying.
